(19) United States
(12) Patent Application Publication
(10) Pub. No.: US 2005/0221853 A1
(43) Pub. Date: Oct. 6, 2005

(54) User authentication using a mobile phone SIM card

(76) Inventor: Kelan C. Silvester, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/816,104

(22) Filed: Mar. 31, 2004

(51) Int. Cl. H04M 1/00

(52) U.S. Cl. 455/551

(57) ABSTRACT

A method for providing security to a computer system is described. Specifically, the computer periodically polls for an electronic device having a SIM card. If the computer locates such an electronic device, the computer requests authentication from the electronic device. The user of the electronic device is given access to the computer system only if the computer is able to validate the authentication information provided by the electronic device.

### FIELD OF THE INVENTION

The present invention pertains to the field of computer system design. More particularly, the present invention relates to a method of using a mobile phone SIM card for providing a computer user's authentication.

### BACKGROUND OF THE INVENTION

A Subscriber Identity Module (SIM) is a computer chip that is typically used in mobile or cellular phones. A SIM generally has memory for storing data, a processor, and applications that allow a user to interact with the SIM. The memory is used to store data such as phone numbers, messages, and email.

A SIM card may be removed from a mobile phone. The interfaces between a mobile handset and the SIM card are standardized. Thus, the contents of a mobile phone are readily transferable from one mobile phone to another by swapping the SIM card.

### BRIEF DESCRIPTION OF THE DRAWINGS

FIG. 1 is an embodiment of a computer system for protecting against unauthorized access to a computer;

FIG. 2 is a flowchart of a procedure for polling for SIM cards; and

FIG. 3 is a flowchart of a procedure for authenticating a computer user.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

A computer system may have confidential applications and data stored in the system's memory. To prevent unauthorized access, most computer systems only employ a username and a password. Thus, a person who wishes to steal confidential information from a computer system would only need the owner's username and password to gain access. A variety of unscrupulous methods exist to steal or alter the usemame and password for malicious intent. Additional levels of protection would help to prevent theft of confidential information of a computer system.

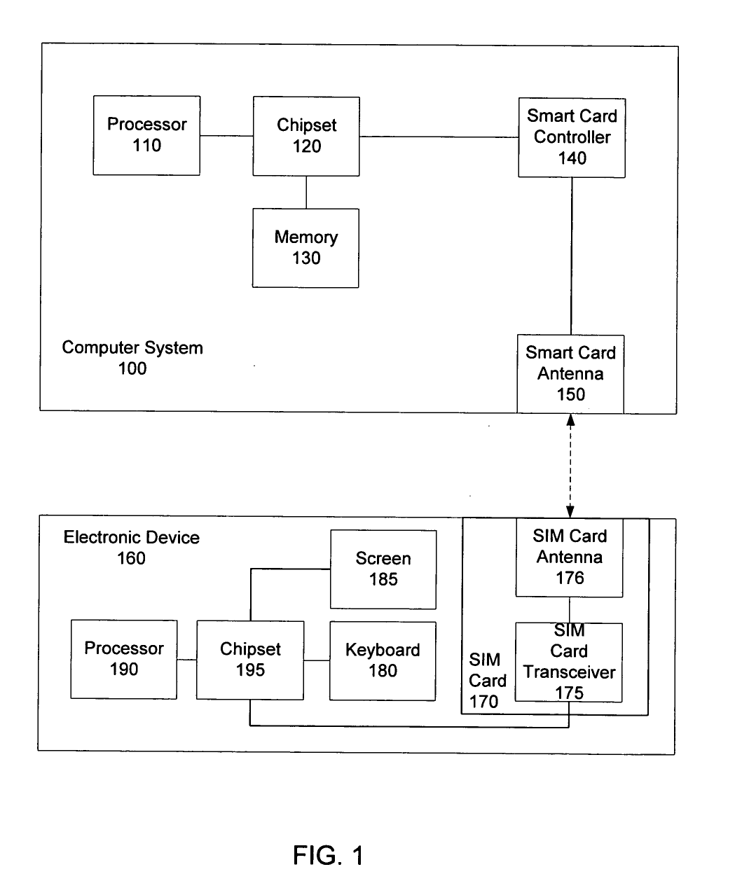

User authentication credentials on an external SIM smart card may be used to provide additional protection against unauthorized access to a computer and its data. FIG. 1 depicts a computer system 100 that requires a SIM card 170 to provide certain information before a user is given access to the computer system 100. The computer system 100 may comprise a processor 110. The processor 110 may be coupled to a chipset 120. The chipset 120 may be coupled to a memory 130 and a smart card controller 140 through a Universal Serial Bus (USB) or a Peripheral Component Interconnect (PCI) bus. The smart card controller 140 may be coupled to a smart card antenna 150.

The SIM card 170 may be part of an electronic device 160. The electronic device 160 may comprise a processor 190. The processor 190 may be coupled to a chipset 195. The chipset 195 may be coupled to a keyboard 180, a display or screen 185, and a SIM card 170. The SIM card 170 may comprise a transceiver 175 and an antenna 176. The electronic device 160 may be a mobile or cellular phone, a pager, or a personal digital assistant (PDA).

The keyboard 180 provides a user of the electronic device 160 with an interface to the SIM card 170. For example, the user may request to read data from the SIM card 170 by pressing certain keys of the keyboard 180. The requested information may then be made available on the screen 185 by the processor 190 and the chipset 195. Similarly, the user may be required to enter a specific character sequence before the mobile device 160 grants access to data found on the SIM card 170.

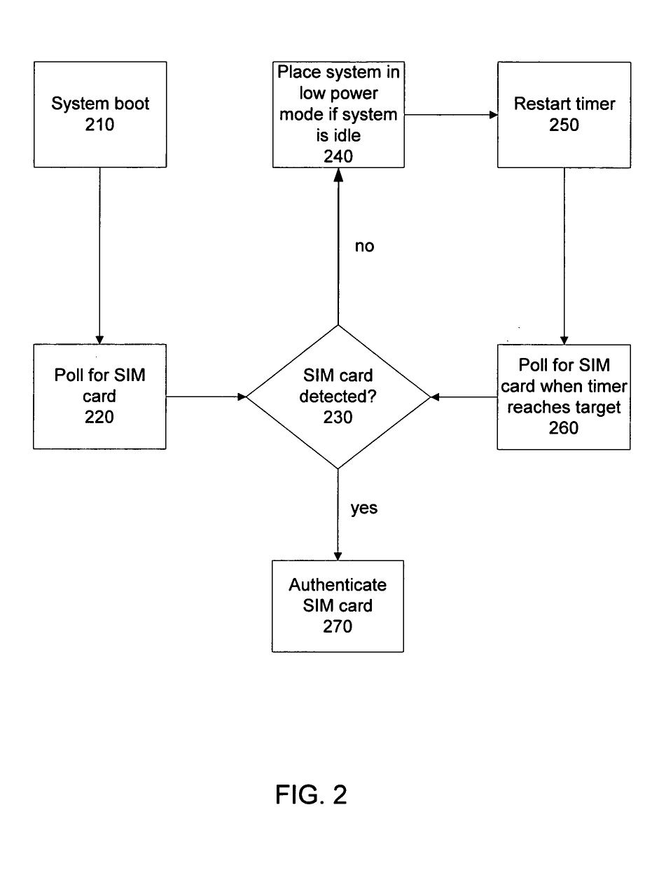

The computer system 100 may communicate with the electronic device 160 and the SIM card 170 via radio signals transmitted between the smart card antenna 150 of the computer system 100 and the SIM card antenna 176 of the electronic device 160. The SIM card transceiver 175 may transmit and receive signals. Before the SIM card 170 may provide authenticating information, the computer system 100 must locate the SIM card 170. For one embodiment of the invention, FIG. 2 depicts a procedure for polling for SIM cards that are in the vicinity of the computer system 100.

The computer system 100 boots up in operation 210. The processor 110 then polls for SIM cards in operation 220. The processor 110 may accomplish this task by executing software code in a device driver running on the host processor 110. The device driver may then issue the command to a smart card antenna 150 to poll for SIM cards through a smart card controller 140. If a SIM card 170 is detected in operation 230, the processor 110 authenticates the SIM card 170 in operation 270.

However, if a SIM card is not detected in operation 230, the computer system 100 is placed in a low power mode in operation 240 if the computer system 100 is idle. The low power mode helps the computer system 100 reduce power consumption and extend battery life. Next, the processor 110 restarts a timer or a counter in operation 250. The timer has a predefined target.

For one embodiment of the invention, the timer target is 490 milliseconds. When the timer reaches the target, the processor 110 sends a request to the smart card antenna 150 through chipset 120 and smart card controller 140 to poll for SIM cards in operation 260. The poll time may be for 10 milliseconds. Thus, for this embodiment of the invention, the processor 110 polls for available SIM cards for 10 milliseconds twice every second.

After polling for SIM cards in operation 260, the processor 110 again checks whether a SIM card is detected in operation 230. The smart card antenna 150 may use a radio frequency of 13.56 Megahertz to poll for available SIM cards. This radio frequency may require for the electronic device 160 having a SIM card 170 to be within 15 centimeters for the smart card antenna 150 to be able to detect the SIM card 170. This proximity requirement makes stealing user credentials via wireless link difficult because a thief would need to be within 15 centimeters of the electronic device 160.

Further, the electronic device 160 may include additional provisions to protect access to the SIM card 170 through a wireless link. For example, the electronic device 160 may transmit a signal at a given frequency to a device requesting user credentials. The electronic device 160 may then wait for a response at the same frequency. From the amount of time it took for the response to be received, the electronic device 160 may calculate its approximate distance from the requesting device. The closer a requesting device is from the electronic device 160, the faster the response should arrive. The electronic device 160 may choose to ignore requests from requesting devices that are a considerable distance from the electronic device 160. Thus, potentially high-powered receivers found in malicious host devices will be denied access to data from the electronic device 160 despite having the transceiver power to do so.

The smart card antenna 150 may have a reader for receiving data from the SIM card 170. The smart card antenna 150 may have a coil antenna that transmits power and data. The coil antenna may induce power from the computer system 100. The induced alternating current voltage is then rectified to provide a voltage source for the reader device. The reader starts operating when the direct current voltage reaches a certain level.

The data transmission bit rate for data returned to the reader may be derived by a synchronized clock source. The synchronized clock source may be received by the smart card controller 140. The smart card controller 140 may then generate an internal clock by dividing the frequency of the synchronized clock source.

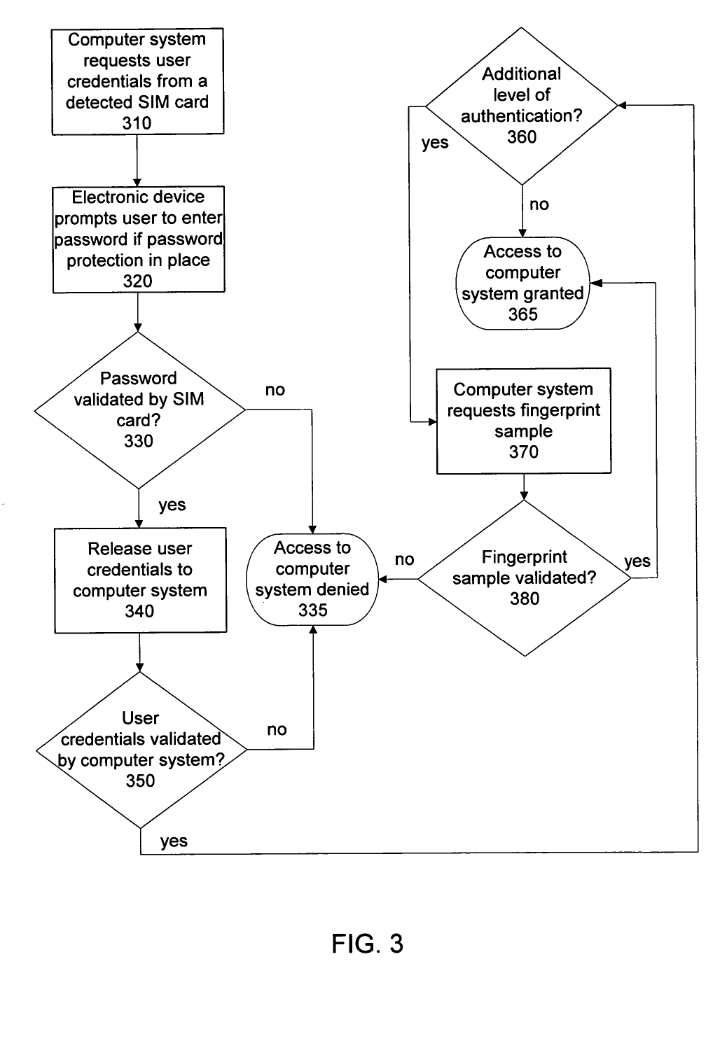

FIG. 3 depicts a method for authenticating a computer user once a smart card 170 is detected within the range of the smart card antenna 150. The computer system 100 requests user credentials from the detected SIM card 170 in operation 310. The request may include a public encryption key of the owner of the computer system 100 and an authentication certificate for the computer system 100. Alternatively, the computer system 100 may include a public encryption key generated just for this specific wireless link with electronic device 160. The use of public/private key encryption of transmitted data across the wireless link helps to protect the transmitted data.

The public key encryption can only be decrypted with a matching private key. While the computer system 100 may freely distribute the public key, the private key is not revealed. The size of the keys may range from 512 bits to 2048 bits. The strength of the encryption depends on the encryption algorithm with the size of the encryption key.

The computer system 100 may also provide an authentication certificate when requesting for user credentials in operation 310. This would allow the electronic device 160 to authenticate the computer system 100. Without this level of authentication, electronic device 160 may lack reasonable justification for releasing the user's credentials to the computer system 100.

If the electronic device 160 has a password protection scheme in place as determined by configuration settings found on the SIM card 170, the electronic device 160 prompts the user to enter a password in operation 320. The user then enters the password into the electronic device 160 using the keyboard 180. If the password entered by the user is not correct in operation 330, access to the computer system 100 is automatically denied in operation 335 because the electronic device 160 ceases to make further communications with the computer system 100.

On the other hand, if the password is validated by the SIM card 170 in operation 330, the electronic device 160 releases user credentials to the computer system 100 in operation 340. The computer system 100 receives the authentication certificate and validates the user credentials in operation 350. The authentication certificate or credentials may be protected by a public or private key encryption to prevent the threat of alteration or theft during data transmission. The public key may have been defined and exchanged during a first-time connection or configuration between the computer system 100 and the electronic device 160.

During the configuration session, the user may have been prompted for his acknowledgment to transfer public keys to the computer system 100. This acknowledgment may have required for the user to enter the password on the electronic device 160 and a similar acknowledgement on the computer system 100. Having the user consciously approve the key exchange may help reduce the chance of a malicious entity requesting user credentials from the electronic device 160 by simply making a request and providing a public key.

After exchanging public keys, the keys can be used to encrypt data that may only be decrypted by the owner of the private key. For example, the electronic device 160 may have the public key of the computer system 100. When requested to deliver user credentials, the electronic device 160 can use that public key to encrypt the user credentials and send it to any system that requests the data. Only the legitimate owner or user of the computer system 100 will be able to decrypt the user credentials since only the computer system 100 has the matching private key used for decryption.

The computer system 100 decrypts the response from the electronic device 160 and then validates the user credentials. The user credential may be a x.509 certificate. If the computer system 100 is unable to validate the user credentials received from the electronic device 160, access to the computer system 100 is denied.

If the computer system 100 validates the user credentials received from the electronic device 160, the computer system 100 checks for additional levels of authentication in operation 360. If there are no further levels of authentication, then access to the computer system 100 is granted in operation 365.

For one embodiment of the invention, the computer system 100 requests for a fingerprint sample in operation 370 as an additional level of authentication. If the fingerprint sample is validated in operation 380, the user is granted access to the computer system 100 in operation 365. However, if the fingerprint sample is not validated in operation 380, access to the computer system 100 is denied in operation 335.

In the foregoing specification the invention has been described with reference to specific exemplary embodiments thereof. It will, however, be evident that various modification and changes may be made thereto without departure from the broader spirit and scope of the invention as set forth in the appended claims. The specification and drawings are, accordingly, to be regarded in an illustrative rather than restrictive sense.

1. A computer system, comprising:
a processor; and
a controller coupled to the processor that periodically polls for the presence of a Subscriber Identity Module (SIM) card.

2. The computer system of claim 1, wherein the computer system is in low power mode if the system is idle.

3. The computer system of claim 1, wherein the computer system polls for a SIM card for 10 millisecond twice every second.

4. The computer system of claim 1, wherein the SIM card is in a mobile phone.

5. The computer system of claim 1, wherein the processor executes software code to provide instructions to the controller.

6. The computer system of claim 5, further comprising an antenna coupled to the controller, wherein the controller sends a command through the antenna to request a user of a detected SIM card to provide authentication credentials.

7. The computer system of claim 6, wherein the processor gives the user access to data of the computer system if the credentials provided by the SIM card are authenticated.

8. The computer system of claim 1, wherein the antenna induces an alternating current (AC) voltage.

9. The computer system of claim 8, wherein the AC voltage is rectified to provide a voltage source to a reader.

10. The computer system of claim 8, wherein the antenna transmits data to the SIM card.

11. The computer system of claim 9, wherein the smart card controller receives a synchronized clock source and divides a frequency of the clock source to generate an internal clock frequency.

12. The computer system of claim 11, wherein the internal clock frequency of the controller determines a data transmission bit rate for data received by the antenna.

13. A computer system, comprising:
means for transmitting power and data to a proximity device of the computer system;
means for decrypting encrypted information sent by the proximity device; and
means for authenticating a user's credentials.

14. The computer system of claim 13, further comprising:
means for conserving power while polling for an external authenticating device.

15. The computer system of claim 13, further comprising:
means for generating a clock in the proximity device.

16. The computer system of claim 14, further comprising:
means for communicating with the external authenticating device.

17. A mobile phone, comprising:
a Subscriber Identity Module (SIM) card that provides credentials for a wireless telecommunications user and credentials to authenticate to a computer; and
a keyboard coupled to the SIM card, wherein the user enters a code with the keyboard before the SIM card provides authentication credentials to the computer.

18. The mobile phone of claim 17, wherein the SIM card comprises a proximity interface to enable transmission of data to the computer.

19. The mobile phone of claim 17, wherein the SIM card's data is configured if a communications link is established with the computer and the user has entered the correct code.

20. The mobile phone of claim 17, wherein the SIM card communicates with the computer if the mobile phone is 15 centimeters or less from the computer.

21. The mobile phone of claim 17, wherein the SIM card communicates with the computer via a radio frequency.

22. The mobile phone of claim 21, wherein the radio frequency is 13.56 Megahertz.

23. A method, comprising:
operating in a low power mode;
polling for a smart card;
identifying a smart card; and
requesting user credentials from the smart card.

24. The method of claim 23, further comprising:
receiving a certificate from the smart card; and
authenticating the certificate.

25. The method of claim 24, further comprising:
prompting for additional user authentication before giving a user access to data on a computer.

26. The method of claim 25, wherein a fingerprint sample is used to provide additional user authentication.

27. The method of claim 23, wherein the smart card is polled within a 15 centimeters range.

28. The method of claim 23, further comprising:
returning to the low power mode if a smart card is not identified.

29. The method of claim 24, wherein the certificate received from the smart card is encrypted using a public key, wherein the certificate is decrypted using a private key of the computer.

30. The method of claim 29, wherein the certificate is a x.509 certificate.
